(19) United States
(12) Patent Application Publication
(10) Pub. No.: US 2022/0221984 A1
(43) Pub. Date: Jul. 14, 2022

(54) INPUT DEVICE AND PROGRAM THEREFOR

(71) Applicant: TOSHIBA TEC KABUSHIKI KAISHA, Tokyo (JP)

(72) Inventors: Satoshi YOKOTE, Tokyo (JP); Hajime KANAZAWA, Tokyo (JP); Kentaro HIRAYAMA, Fujisawa (JP)

(73) Assignee: TOSHIBA TEC KABUSHIKI KAISHA, Tokyo (JP)

(21) Appl. No.: 17/525,699

(22) Filed: Nov. 12, 2021

(30) Foreign Application Priority Data
Jan. 13, 2021 (JP) 2021-003510

(51) Int. Cl. G06F 3/0488

(52) U.S. Cl. CPC G06F 3/04886

(57) ABSTRACT

An input device includes a display and a processor. The display includes a screen. The processor is configured to cause the screen to display a first key layout in which a set of numeric keys is arranged in a first arrangement. The processor is also configured to perform a first determination of whether a part on the screen is specified. The processor is also configured to, if a first part of the screen has been specified, cause the screen to display a second key layout in which the set of numeric keys is arranged in a second arrangement. The processor is also configured to receive, based on an operation on the first key layout or the second key layout, an input of at least one input numeric key of the numeric keys.

### CROSS-REFERENCE TO RELATED APPLICATION

This application is based upon and claims the benefit of priority from Japanese Patent Application No. 2021-003510, filed on Jan. 13, 2021, the entire contents of which are incorporated herein by reference.

### FIELD

Embodiments described herein relate generally to an input device and a program therefor.

### BACKGROUND

As an example, there has been an input device on which ten numeric keys, to which numbers “0” to “9” are respectively allocated, are arranged for an input of a password necessary for credit card settlement. An input device of a hard key type on which numeric keys formed by hard keys are arranged in a regular arrangement was the mainstream approach used in the past.

Providing, for example, a palpable protrusion in a numeric key of “5” enables even a visually impaired person to use the input device of the hard key type. However, in the input device of the hard key type, there is a concern that an outsider may be able to guess a numerical string, that is, a password input from a movement of a finger of an operator.

Therefore, recently, an input key of a soft key type using a touch panel has been developed. In the input device of the soft key type, an arrangement of numeric keys can be changed as appropriate. Since regularity of the arrangement of the numeric keys is lost by changing the arrangement of the numeric keys, an outsider cannot guess a password from a movement of a finger of an operator. However, if the arrangement of the numeric keys does not have regularity, a visually impaired person cannot use the input device of the soft key type because the visually impaired person does not know which numeric keys are present in which positions.

### DESCRIPTION OF THE DRAWINGS

FIG. 1 is a block diagram illustrating a main part circuit configuration of an input device according to an embodiment;

FIG. 2 is a schematic diagram illustrating a data structure of a key table included in the input device;

FIG. 3 is a schematic diagram illustrating an image example of a second key layout;

FIG. 4 is a schematic diagram illustrating an image example of a first key layout;

FIG. 5 is a flowchart illustrating a procedure of main information processing executed by a processor of the input device;

FIG. 6 is a flowchart illustrating a main processing procedure of a visually impaired person mode in FIG. 5;

FIG. 7 is a schematic diagram used for an explanation of the operation of the input device;

FIG. 8 is a schematic diagram used for the explanation of the operation of the input device;

FIG. 9 is a schematic diagram used for another explanation of the operation of the input device; and

FIG. 10 is a schematic diagram used for the other explanation of the operation of the input device.

### DETAILED DESCRIPTION

Various of the embodiments described herein may provide, in order to solve the problems described above, an input device of a soft key type that even a visually impaired person can use for an input of a password and the like.

According to an embodiment, an input device includes a display unit, a first display control unit, a determining unit, a second display control unit, and a receiving unit. The first display control unit causes a screen of the display unit to display a first key layout in which numeric keys are arranged in a random arrangement. The determining unit determines whether any part on the screen is specified by the determined operation. If any part on the screen is specified by the determined operation, the second display control unit causes the screen to display, with the part set as a reference, a second key layout in which numeric keys are arranged in a regular arrangement. The receiving unit receives, according to an operation on the first key layout or the second key layout, an input of the numeric key arranged in a position of the operation.

An input device according to an embodiment is explained below with reference to the drawings.

This embodiment illustrates an input device used in inputting a password in various settlement means such as a credit card or a debit card used for settlement of a commercial transaction.

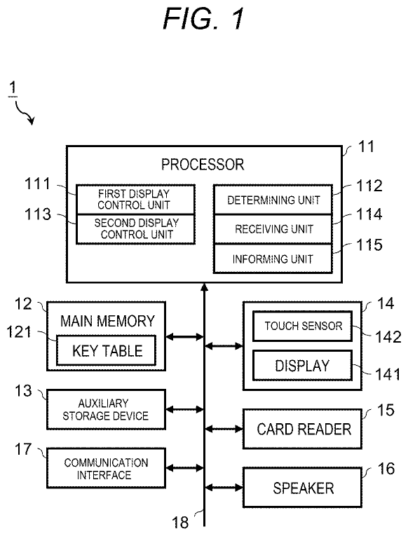

FIG. 1 is a block diagram illustrating a main part circuit configuration of an input device 1 according to this embodiment. The input device 1 includes a processor 11, a main memory 12, an auxiliary storage device 13, a touch panel 14, a card reader 15, a speaker 16, a communication interface 17, and a system bus 18. The system bus 18 includes an address bus and a data bus. In the input device 1, a computer is configured by connecting the processor 11, the main memory 12, the auxiliary storage device 13, the touch panel 14, the card reader 15, the speaker 16, and the communication interface 17 with the system bus 18.

The processor 11 is equivalent to a central part of the computer. The processor 11 controls the units according to an operating system or application programs in order to realize various functions of the input device 1. The processor 11 is, for example, a Central Processing Unit (CPU).

The main memory 12 is equivalent to a main storage part of the computer. The main memory 12 includes a nonvolatile memory region and a volatile memory region. The main memory 12 stores the operating system and the application programs in the nonvolatile memory region. The main memory 12 stores, in the volatile memory region, data necessary for the processor 11 to execute processing for controlling the units. The data of this type is sometimes stored in the nonvolatile memory region. The main memory 12 uses the volatile memory region as a work area in which data is rewritten as appropriate by the processor 11. The nonvolatile memory region is, for example, a Read Only Memory (ROM). The volatile memory region is, for example, a Random Access Memory (RAM).

The auxiliary storage device 13 is equivalent to an auxiliary storage part of the computer. As the auxiliary storage device 13, a storage device such as a Solid State Drive (SSD), a Hard Disc Drive (HDD), or an Electric Erasable Programmable Read-Only Memory (EEPROM), or any combination thereof, may be used. The auxiliary storage device 13 stores data used by the processor 11 in performing various kinds of processing, data generated by the processing in the processor 11, and the like. The auxiliary storage device 13 sometimes stores application programs.

The application programs stored in the main memory 12 or the auxiliary storage device 13 include a control program explained below. A method of installing the control program in the main memory 12 or the auxiliary storage device 13 is not particularly limited. The control program can be installed in the main memory 12 or the auxiliary storage device 13 by recording the control program in a removable recording medium or distributing the control program by communication via a network. A form of the recording medium may be any form if the recording medium can store programs and can be read by a device like a CD-ROM, a memory card, or the like.

The touch panel 14 is an input device obtained by combining a display 141, functioning as a display unit (display), and a touch sensor 142, functioning as a detecting unit (detector). The display 141 includes a screen for displaying an image for receiving an input of an operator (user). The touch sensor 142 detects a position on the screen touched by the operator. The touch panel 14 acquires, from the position on the screen detected by the touch sensor 142 and information concerning an image displayed at the position, data input by the operator.

The card reader 15 is an input device for reading data recorded in a credit card. The card reader 15 is an integrated circuit (IC) card reader corresponding to an IC card of a contact type or a noncontact type. The card reader 15 may be a magnetic card reader adapted to a magnetic card.

The speaker 16 is an output device that reproduces an operation sound, an electronic sound such as a warning sound, or a sound synthesized by a sound synthesizing device.

The communication interface 17 is an interface that exchanges data signals with a settlement device such as a Point Of Sales (POS) terminal or a checkout machine that executes checkout processing. For example, a data signal of the credit card read by the card reader 15 is output to the settlement device via the communication interface 17. A data signal of a password input via the touch panel 14 is output to the settlement device via the communication interface 17. The input device 1 having such a configuration is an input device of a soft key type that displays an image of a key layout on the display 141 of the touch panel 14 and receives a key input. The key layout is arrangement of various keys for password input including numeric keys of “0,” “1,” “2,” “3,” “4,” “5,” “6,” “7,” “8,” and “9,” a “correct” key, and an “execute” key. As the key layout, there are a first key layout, in which the numeric keys are arranged in a random arrangement, and a second key layout, in which the numeric keys are arranged in a regular arrangement.

The random arrangement means an arrangement in which the numeric keys of “1” to “9” are not arranged in the order of “1” to “9,” that is, an arrangement in which the numeric keys are arranged at random. On the other hand, the regular arrangement means an arrangement in which the numeric keys of “1” to “9” are arranged in the order of “1” to “9” and the numeric key of “0” is arranged in a determined position. For example, if the numeric keys of “1” to “9” are arranged in a 3×3 matrix shape, an arrangement in which the numeric keys are arranged as “1,” “2,” “3,” “4,” “5,” “6,” “7,” “8,” and “9” horizontally from the upper left, an arrangement in which the numeric keys are arranged as “1,” “2,” “3,” “4,” “5,” “6,” “7,” “8,” and “9” vertically from the upper left, an arrangement in which the numeric keys are arranged as “1,” “2,” “3,” “4,” “5,” “6,” “7,” “8,” and “9” horizontally from the upper right, an arrangement in which the numeric keys are arranged as “1,” “2,” “3,” “4,” “5,” “6,” “7,” “8,” and “9” vertically from the upper right, an arrangement in which the numeric keys are arranged as “1,” “2,” “3,” “4,” “5,” “6,” “7,” “8,” and “9” horizontally from the lower left, an arrangement in which the numeric keys are arranged as “1,” “2,” “3,” “4,” “5,” “6,” “7,” “8,” and “9” vertically from the lower left, an arrangement in which the numeric keys are arranged as “1,” “2,” “3,” “4,” “5,” “6,” “7,” “8,” and “9” horizontally from the lower right, and an arrangement in which the numeric keys are arranged as “1,” “2,” “3,” “4,” “5,” “6,” “7,” “8,” and “9” vertically from the lower right are considered to be regular arrangements.

The input device 1 includes a key table 121 in order to function as the input device of the soft key type. The key table 121 is configured by using a part of the volatile memory region of the main memory 12. The key table 121 may be configured using a part of the storage region of the auxiliary storage device 13.

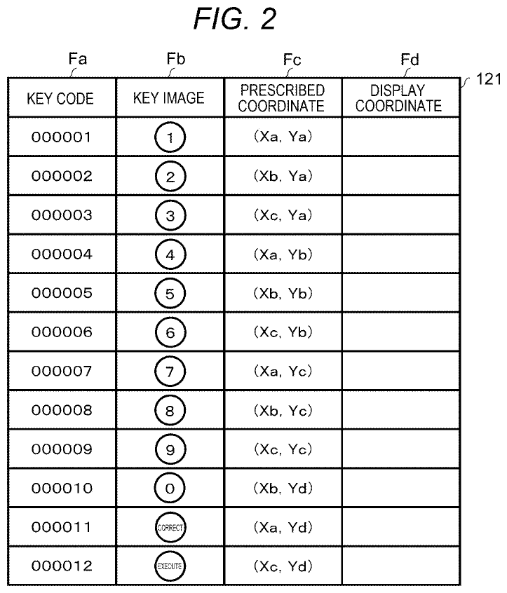

FIG. 2 is a schematic diagram illustrating a data structure of the key table 121. The key table 121 includes a first field Fa in which key codes are described, a second field Fb in which key images are described, a third field Fc in which prescribed coordinates are described, and a fourth field Fd in which display coordinates are described. The key table 121 may include other fields.

The key codes are unique codes respectively allocated to the various keys for password input, that is, the numeric keys of “0” to “9,” the “correct” key, and the “execute” key. The key images are image data of the various keys identified by the key codes described in the first field Fa. The key images are, for example, images formed by writing numbers or characters in circles. The key images may be images of other forms.

The prescribed coordinates are coordinate data indicating prescribed arrangement places of the key images described in the second field Fb. In this embodiment, the arrangement of the numeric keys provided in a telephone are set as the regular arrangement. That is, a 4×3 matrix arrangement in which the numeric keys of “1,” “2,” and “3” are arranged from the left, the numeric keys of “4,” “5,” and “6” are arranged from the left below the numeric keys of “1,” “2,” and “3,” the numeric keys of “7,” “8,” and “9” are arranged from the left below the numeric keys of “4,” “5,” and “6,” the numeric key of “0” is arranged in the center below the numeric keys of “7,” “8,” and “9,” the “correct” key is arranged on the left side of the numeric key of “0,” and the “execute” key is arranged on the right side of the numeric key of “0” is set as the regular arrangement. The prescribed coordinates are represented by two-dimensional coordinates having the horizontal direction of the screen in the display 141 as an X axis and having the vertical direction of the screen as a Y axis. In this embodiment, the prescribed coordinates of the key images are set such that the numeric key of “5” is arranged in the center of the screen and the numeric key of “4” and the numeric key of “6” are arranged in the X-axis direction across the numeric key of “5.” Therefore, X coordinates (Xa) of the number keys of “1,” “4,” and “7” and the “correct” key coincide. X coordinates (Xb) of the numeric keys of “2,” “5,” “8,” and “0” coincide. X coordinates (Xc) of the numeric keys of “3,” “6,” and “9” and the “execute” key coincide. Y coordinates (Ya) of the numeric keys of “1,” “2,” and “3” coincide. Y coordinates (Yb) of the numeric keys “4,” “5,” and “6” coincide. Y coordinates (Yc) of the numeric keys “7,” “8,” and “9” coincide. Y coordinates (Yd) of the numeric key of “0,” the “correct” key, and the “execute” key coincide.

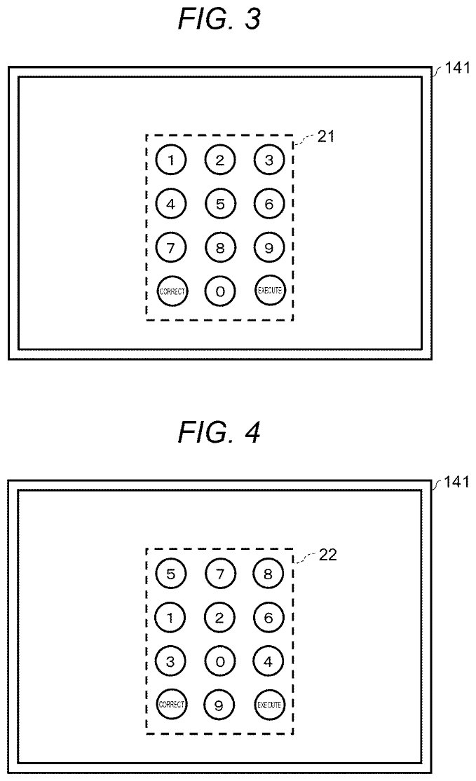

The display coordinates are coordinate data indicating display positions on the screen in the display 141. The display coordinates are represented by two-dimensional coordinates having the horizontal direction of the screen in the display 141 as an X axis and having the vertical direction of the screen as a Y axis. Therefore, if the prescribed coordinates set in the third field Fc are directly described in the fourth field Fd corresponding to the third field Fc, an image 21 of a key layout illustrated in FIG. 3 is displayed on the display 141. That is, the image 21 of the key layout in which the numeric key of “5” is arranged in the center of the screen in the arrangement of the numeric keys provided in the telephone is displayed. The key layout of the image 21 is an example of the second key layout in which the numeric keys are arranged in the regular arrangement.

On the other hand, if the prescribed coordinates set in the third field Fc are described in the fourth field Fd at random, for example, an image 22 of a key layout illustrated in FIG. 4 is displayed on the display 141. The image 22 is an example in which the prescribed coordinates of the numeric keys are described in the fourth field Fd as display coordinates of other numeric keys as described below.

A prescribed coordinate (Xa, Ya) of the numeric key of “1”→a display coordinate of the numeric key of “5”

A prescribed coordinate (Xb, Ya) of the numeric key of “2”→a display coordinate of the numeric key of “7”

A prescribed coordinate (Xc, Ya) of the numeric key of “3”→a display coordinate of the numeric key of “8”

A prescribed coordinate (Xa, Yb) of the numeric key of “4”→a display coordinate of the numeric key of “1”

A prescribed coordinate (Xb, Yb) of the numeric key of “5”→a display coordinate of the numeric key of “2”

A prescribed coordinate (Xc, Yb) of the numeric key of “6”→a display coordinate of the numeric key of “6”

A prescribed coordinate (Xa, Yc) of the numeric key of “7”→a display coordinate of the numeric key of “3”

A prescribed coordinate (Xb, Yc) of the numeric key of “8”→a display coordinate of the numeric key of “0”

A prescribed coordinate (Xc, Yc) of the numeric key of “9”→a display coordinate of the numeric key of “4”

A prescribed coordinate (Xb, Yd) of the numeric key of “0”→a display coordinate of the numeric key of “9”

A prescribed coordinate (Xa, Yd) of the “correct” key and a prescribed coordinate (Xc, Yd) of the “execute” key are directly described in the fourth field Fd as the display coordinates of the “correct” key and the “execute” key” corresponding to the prescribed coordinates.

As illustrated in FIG. 4, the key layout of the image 22 does not have regularity about the numeric keys. That is, the key layout of the image 22 is an example of the first key layout in which the numeric keys are arranged in a random arrangement.

Referring back to FIG. 1, the input device 1 includes a first display control unit 111 (first display controller), a determining unit 112 (processor, determination controller), a second display control unit 113 (second display controller), a receiving unit 114 (receiver), and an informing unit 115 (informer) in order to function as the input device of the soft key type explained above. The first display control unit 111, the determining unit 112, the second display control unit 113, the receiving unit 114, and the informing unit 115 are functions realized by the processor 11 executing information processing according to a control program. Therefore, subsequently, main information processing executed by the processor 11 according to the control program is explained.

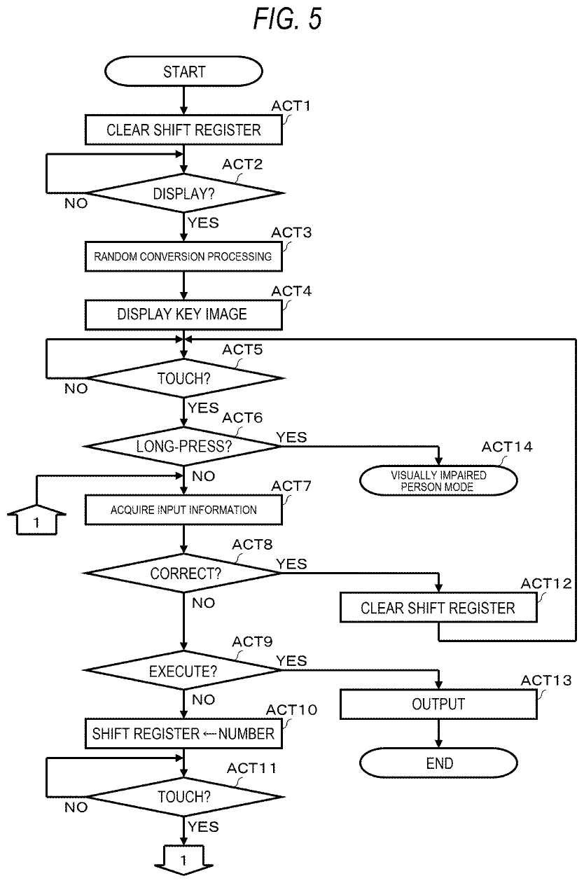

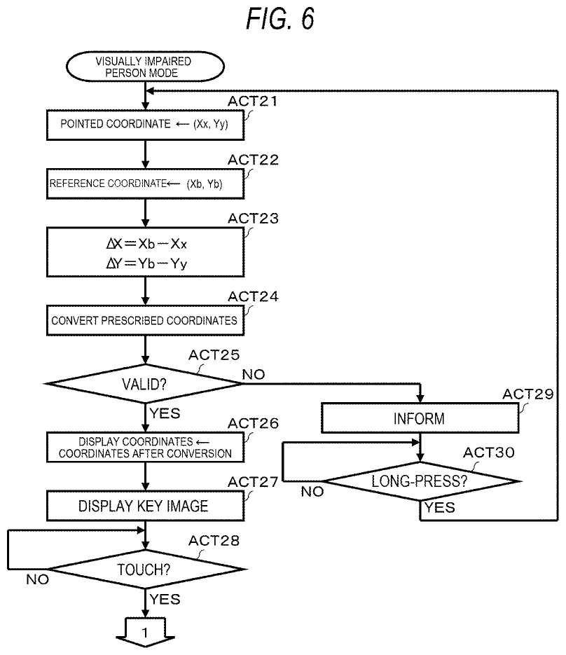

FIGS. 5 and 6 are flowcharts illustrating a procedure of the main information processing executed by the processor 11 according to the control program. The procedure explained below is an example. The procedure is not particularly limited if the same action effects can be obtained.

In ACT1, the processor 11 clears a shift register. The shift register is a region for temporarily storing data of a numerical string equivalent to a password. The shift register is formed in, for example, the volatile memory region of the main memory 12.

In ACT2, the processor 11 waits for a display command. The display command is, for example, a command output from the settlement device to the input device 1 if credit card settlement is selected in the settlement device. If receiving the display command via the communication interface 17, the processor 11 proceeds from ACT2 to ACT3. In ACT3, the processor 11 executes random conversion processing of display coordinates. This processing is processing for allocating the prescribed coordinates described in the third field Fc to the fourth field Fd of the key table 121 at random. Specifically, the prescribed coordinates corresponding to the numeric keys of “0” to “9” are described in the fourth field Fd respectively as display coordinates corresponding to the numeric keys. The prescribed coordinate (Xa, Yd) corresponding to the “correct” key and the prescribed coordinate (Xc, Yd) corresponding to the “execute” key are directly described in the fourth field Fd as display coordinates corresponding to the “correct” key and the “execute” key.

It is optional to determine as display coordinates corresponding to which numeric keys the prescribed coordinates corresponding to the numeric keys of “0” to “9” are allocated. A pattern of the allocation changes every time a display command is received. Therefore, the display coordinates corresponding to the numeric keys of “0” to “9” change at least between a display command reception time of the last time and a display command reception time of this time.

If ending the random conversion processing of the display coordinates, the processor 11 proceeds to ACT4. In ACT4, the processor 11 causes, according to the display coordinates of the key table 121, the display 141 of the touch panel 14 to display an image of a key layout. The image at this time is, for example, as illustrated in FIG. 4, the image 22 of the first key layout in which the numeric keys are arranged in the random arrangement.

The processor 11 functions as the first display control unit 111 by executing the processing in ACT3 and ACT4 in cooperation with the display 141 of the touch panel 14. That is, the processor 11 causes the screen of the display 141 to display the first key layout in which the numeric keys are arranged in the random arrangement.

If ending the processing in ACT4, the processor 11 proceeds to ACT5. In ACT5, the processor 11 waits for the screen of the display 141 to be touched. If detecting, with a signal from the touch sensor 142, that the screen is touched, the processor 11 proceeds from ACT5 to ACT6. In ACT6, the processor 11 confirms whether the touch is a long-press operation. For example, if a state in which the screen is pressed by the touch lasts for three seconds or more, the processor 11 acknowledges that the touch is the long-press operation. If the state in which the screen is pressed by the touch lasts for less than three seconds, the processor 11 acknowledges that the touch is not the long-press operation.

The processor 11 functions as the determining unit 112 by executing the processing in ACT5 and ACT6 in cooperation with the touch sensor 142 of the touch panel 14. That is, the processor 11 determines whether any part on the screen on which the first key layout is displayed is specified by a determined operation. The determined operation means, for example, the long-press operation for three seconds or more. It goes without saying that a threshold for determining whether the touch is the long-press operation is not limited to three seconds.

If the touch is not the long-press operation, the processor 11 proceeds from ACT6 to ACT7. In ACT7, the processor 11 acquires input information from the touch panel 14. As the input information, there are number information obtained if any one numeric key among the numeric keys of “0” to “9” is touched, correction information obtained if the “correct” key is touched, and execution information obtained if the “execute” key is touched. The number information includes a number allocated to the touched numeric key.

In ACT8, the processor 11 confirms whether the input information is the correction information. If the input information is not the correction information, the processor 11 proceeds from ACT8 to ACT9. In ACT9, the processor 11 confirms whether the input information is the execution information. If the input information is not the execution information, that is, if the input information is the number information, the processor 11 proceeds from ACT9 to ACT10. In ACT10, after shifting numbers in respective digits in the shift register to higher order numbers digit by digit, the processor 11 describes the number of the number information in the first digit of the shift register.

Thereafter, in ACT11, the processor 11 waits for the screen of the display 141 to be touched. If detecting, with a signal from the touch sensor 142, that the screen is touched, the processor 11 returns from ACT11 to ACT7. The processor 11 executes the processing in ACT7 and subsequent acts in the same manner as explained above. Therefore, if the input information acquired in ACT7 is the number information, the processor 11 executes the processing in ACT10 again. That is, the processor 11 repeats processing for, after further shifting the numbers in the respective digits in the shift register to higher order numbers digit by digit, describing the number of the number information in the first digit of the shift register.

If the input information is the correction information, the processor 11 proceeds from ACT8 to ACT12. In ACT12, the processor 11 clears the shift register. Thereafter, the processor 11 returns to ACT5. The processor 11 executes the processing in ACT5 and subsequent acts in the same manner as explained above.

If the input information is the execution information, the processor 11 proceeds from ACT5 to ACT13. In ACT13, the processor 11 outputs data of a numerical string described in the shift register to the settlement device as data of a password. Consequently, the data of the password is transmitted to the settlement device via the communication interface 17. Then, the processor 11 ends the information processing executed if the touch, which is not the long-press operation, is performed.

On the other hand, if the touch is the long-press operation, the processor 11 proceeds from ACT6 to ACT14. In ACT14, the processor 11 shifts to processing of a visually impaired person mode.

FIG. 6 is a flowchart illustrating a main part processing procedure of the visually impaired person mode. In ACT21, the processor 11 calculates, as a pointed coordinate (Xx, Yy), a two-dimensional coordinate of a center point of a part touched by the long-press operation on the screen of the display 141. In ACT22, the processor 11 acquires a reference coordinate.

In this embodiment, the processor 11 causes the display 141 to display the image 21 of the second key layout such that the numeric key of “5” is located in the pointed coordinate (Xx, Yy), the numeric key of “4” and the numeric key of “6” are located on the left and the right of the numeric key of “5,” and the numeric key of “2” and the numeric keys of “8” and “0” are located above and below the numeric key of “5.” Therefore, in ACT22, a prescribed coordinate (Xb, Yb) corresponding to the numeric key of “5” is acquired as the reference coordinate.

In ACT23, the processor 11 calculates, according to Expression (1) and Expression (2), below, a shift amount (ΔX, AY) in the X-axis direction and the Y-axis direction of the pointed coordinate (Xx, Yy) with respect to the reference coordinate (Xb, Yb).

ΔX=Xb−Xx (1)

ΔY=Yb−Yy (2)

In ACT24, the processor 11 converts prescribed coordinates corresponding to the numeric keys of “0” to “9” into coordinates in positions shifted by the shift amount (ΔX, ΔY). Specifically, the processor 11 converts the prescribed coordinates as described below.

The prescribed coordinate (Xa, Ya) of the numeric key of “1”→(Xa−ΔX, Ya−ΔY)

The prescribed coordinate (Xb, Ya) of the numeric key of “2”→(Xb−ΔX, Ya−ΔY)

The prescribed coordinate (Xc, Ya) of the numeric key of “3”→(Xc−ΔX, Ya−ΔY)

The prescribed coordinate (Xa, Yb) of the numeric key of “4”→(Xa−ΔX, Yb−ΔY)

The prescribed coordinate (Xb, Yb) of the numeric key of “5”→(Xb−ΔX, Yb−ΔY)

The prescribed coordinate (Xc, Yb) of the numeric key of “6”→(Xc−ΔX, Yb−ΔY)

The prescribed coordinate (Xa, Yc) of the numeric key of “7”→(Xa−ΔX, Yc−ΔY)

The prescribed coordinate (Xb, Yc) of the numeric key of “8”→(Xb−ΔX, Yc−ΔY)

The prescribed coordinate (Xc, Yc) of the numeric key of “9”→(Xc−ΔX, Yc−ΔY)

The prescribed coordinate (Xb, Yd) of the numeric key of “0”→(Xb−ΔX, Yd−ΔY)

In ACT25, the processor 11 determines whether the prescribed coordinates after the conversion are coordinates valid as coordinates on the screen. If all of the prescribed coordinates after the conversion are coordinates present on the screen, the processor 11 acknowledges that the prescribed coordinates are valid. If at least one coordinate among the prescribed coordinates after the conversion is a coordinate absent on the screen, the processor 11 acknowledges that the prescribed coordinates are invalid.

If the prescribed coordinates after the conversion are coordinates valid as coordinates on the screen, the processor 11 proceeds from ACT25 to ACT26. In ACT26, the processor 11 describes the prescribed coordinates after the conversion of the numeric keys in the fourth field Fd of the key table 121 respectively as display coordinates of the same numeric keys. The prescribed coordinates corresponding to the “correct” key and the “execute” key are directly described in the fourth field Fd as display coordinates. In ACT27, the processor 11 causes, according to the display coordinates of the key table 121, the display 141 of the touch panel 14 to display an image of a key layout. The image at this time is the image 21 of the second key layout in which the numeric keys are arranged in a regular arrangement, that is, the arrangement of the numeric keys provided in the telephone.

The processor 11 functions as the second display control unit 113 by executing the processing in ACT21 to ACT27 in cooperation with the display 141 and the touch sensor 142. That is, if detecting, with a signal from the touch sensor 142, that any part on the screen is specified by the long-press operation, the processor 11 causes, with the part set as a reference, the screen of the display 141 to display the second key layout in which the numeric keys are arranged in the regular arrangement.

If ending the processing in ACT27, in ACT28, the processor 11 waits for the screen of the display 141 to be touched. If detecting, with a signal from the touch sensor 142, that the screen is touched, the processor 11 returns from ACT28 to ACT7 in FIG. 5. The processor 11 executes the processing in ACT7 and subsequent acts in the same manner as explained above.

Therefore, if the input information acquired in ACT7 is the number information, after shifting the numbers in the respective digits in the shift register to higher order numbers digit by digit, the processor 11 describes the number of the number information in the first digit. If the input information is the correction information, the processor 11 clears the shift register. If the input information is execution information, the processor 11 outputs the data of the numerical string described in the shift register to the settlement device as data of a password. Then, the processor 11 ends the information processing of the visually impaired person mode.

The processor 11 functions as a receiving unit by executing the processing in ACT7 to ACT10. That is, the processor 11 receives, according to an operation of the first key layout or the second key layout, an input of a numeric key arranged in the position of the operation.

In the processing of the visually impaired person mode, if the position of the pointed coordinate (Xx, Yy) is close to an end portion of the screen, a part of the prescribed coordinates after the conversion are coordinates invalid as coordinates on the screen. In that case, the processor 11 proceeds from ACT25 to ACT29. In ACT29, the processor 11 performs informing (causes an informing output, such as an audio signal or a vibration, to be provided) for letting the operator to know that the image 21 of the second key layout cannot be displayed. For the informing, the speaker 16 is used because the operator is assumed to be a visually impaired person. For example, the processor 11 causes the speaker 16 to generate a warning sound for notifying an operation error. For example, the processor 11 causes the speaker 16 to generate voice for instructing to perform the operation again.

The processor 11 functions as the informing unit 115 by executing the processing in ACT29 in cooperation with the speaker 16. That is, the processor 11 informs if a part specified by a determined operation is a part inappropriate for the display of the second key layout.

In ACT30, the processor 11 ending the informing waits for a long-press operation of the screen of the display 141 to be performed. If detecting, with a signal from the touch sensor 142, that the long-press operation of the screen is performed, the processor 11 returns from ACT30 to ACT21. The processor 11 executes the processing in ACT21 and subsequent acts again.

As explained above, if receiving the display command from the settlement device, as illustrated in FIG. 4, the input device 1 in this embodiment displays various keys for password input in the first key layout on the touch panel 14. The first key layout is a key layout in which the numeric keys are arranged in a random arrangement. The arrangement of the numeric keys is different every time the display command is received. Therefore, even if an outsider views a movement of a finger of the operator who operates the touch panel 14, the outsider cannot guess an input password.

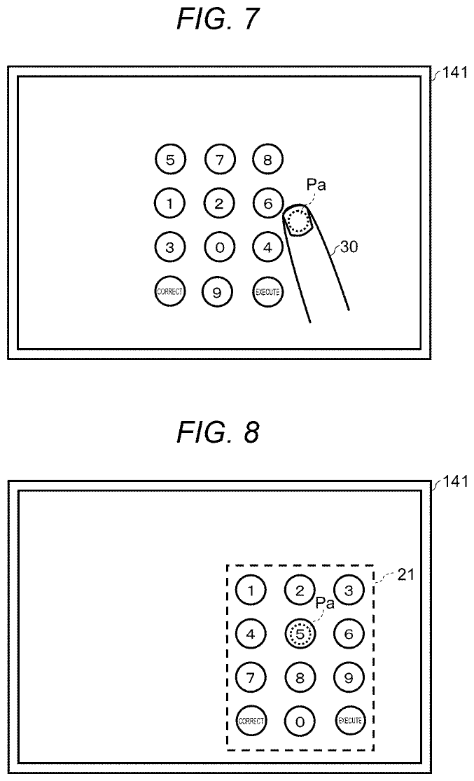

On the other hand, if the operator is a visually impaired person, first, as illustrated in FIG. 7, the operator performs a long-press operation of any position on the screen of the display 141 with one finger 30. Then, a position Pa of a fingertip that performs the long-press operation is specified as the pointed coordinate (Xx, Yy). The shift amount (ΔX, ΔY) in the X-axis direction and the Y-axis direction of the pointed coordinate (Xx, Yy) with respect to the reference coordinate (Xb, Yb) is calculated. Further, the prescribed coordinates corresponding to the numeric keys of “0” to “9” are converted into coordinates of positions shifted by the shift amount (ΔX, ΔY). An image of a key layout is displayed on the display 141 of the touch panel 14 according to the prescribed coordinates after the conversion. As illustrated in FIG. 8, the image at this time is the image 21 of the second key layout in which the numeric key of “5” is located in the position Pa of the fingertip and the other numeric keys are arranged in the arrangement of the numeric keys provided in the telephone.

In this way, if the operator, who is the visually impaired person, long-presses the screen, the various keys for password input are arranged in the arrangement of the numeric keys provided in the telephone such that the numeric key of “5” is located in a long-pressed part of the screen. Therefore, the operator can input a password assuming that the numeric key of “5” is present in the long-pressed part. That is, it is possible to provide the input device 1 of the soft key type that even the visually impaired person can use for an input of a password and the like.

In that case, since the position of the numeric key of “5” set as the reference is the position long-pressed by the operator, the position is not fixed. Therefore, even if an outsider views a movement of the finger of the operator who operates the touch panel 14, it is difficult to guess a password.

If the part specified by the long-press operation is a part inappropriate for the display of the second key layout, informing for letting the operator to know that the image 21 of the second key layout cannot be displayed is performed. The speaker 16 is used for the informing. Therefore, even if the operator is a visually impaired person, the operator can easily learn the informing. The operator checks the informing and long-presses another place of the screen. If the place is appropriate for the display of the second key layout, the image 21 of the second key layout is displayed with the place set as a reference. Therefore, even if the operator long-presses a part inappropriate for the display of the second key layout, the operator only has to long-press another valid part immediately. Therefore, even the visually impaired person can easily take measures. Informing means may adopt a form in which a vibration motor is incorporated in the input device 1 and the main body of the input device 1 is vibrated by the vibration motor.

The input device 1 includes the communication interface 17 for communication with the settlement device. If the “execute” key is pressed, the input device 1 outputs a numerical string input by the numeric keys immediately before the pressing of the “execute” key to the settlement device as a password. Therefore, the input device 1 can be used by being connected to the settlement device as an input device for a password at a credit card settlement time.

The input device 1 according to the embodiment is explained above. However, the embodiment is not limited to the input device 1.

For example, in the embodiment, the device connected to the communication interface 17 is the settlement device. The device is not limited to the settlement device. For example, an automatic teller machine (ATM) of a financial institution, a ticket vending machine of a transportation facility, and the like, may be connected to the communication interface 17 and caused to function as respective password input devices.

In the embodiment, the “determined operation” for specifying any part on the screen on which the first key layout is displayed is the long-press operation. The “determined operation” is not limited to the long-press operation. For example, an operation for drawing a figure such as a circle, a sign, or the like, in any part with a fingertip may be the “determined operation.” Alternatively, an operation for touching any part twice or more at a short span may be the “determined operation.”

For example, an operation for drawing a number “5” with a fingertip may be the “determined operation.” In this case, for example, if an operation for drawing a number “1” with the fingertip is performed, an image of the second key layout may be displayed such that the numeric key of “1” is located in a place where the operation is performed. Such an embodiment can be realized by setting, as the prescribed coordinate (Xa, Ya) corresponding to the numeric key of “1,” the reference coordinate acquired in ACT22 in FIG. 6.

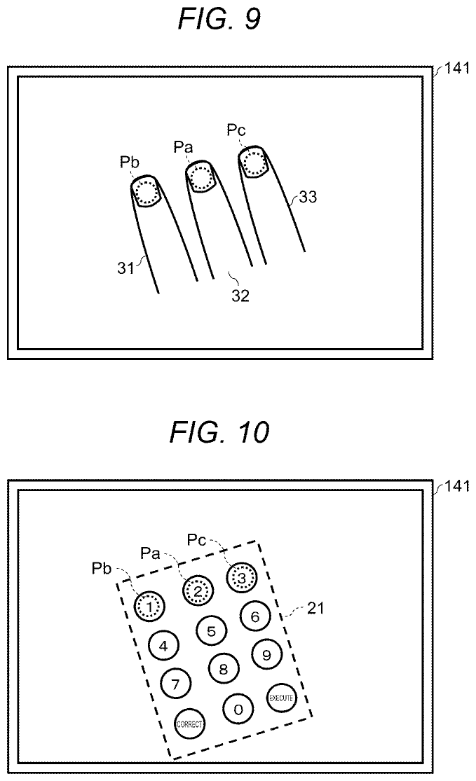

In this embodiment, the operation for performing the long-press operation of any one part on the screen with one finger 30 is illustrated. As another embodiment, as illustrated in FIG. 9, the long-press operation of any three parts on the screen is performed by three fingers 31, 32, and 33. If the long-press operation of the any three parts is performed, the processor 11 acquires a touch position Pb of the finger 31 on the left side on the screen, the touch position Pa of the finger 32 in the center on the screen, and a touch position Pc of the finger 33 on the right side on the screen. As illustrated in FIG. 10, the processor 11 causes the display 141 to display the image 21 of the second key layout such that, for example, the numeric key of “1” is located in the touch position Pb, the numeric key of “2” is located in the touch position Pa, and the numeric key of “3” is located in the touch position Pc.

In such another embodiment, the image 21 of the second key layout is displayed in a size corresponding to an interval among the three fingers 31, 32, and 33. Therefore, since the image 21 of the second key layout is displayed in a size matching the size of the hand of the operator, it is possible to provide the input device 1 that can be easily operated irrespective of sex and age. Since it is not always necessary to perform the long-press operation of the three fingers 31, 32, and 33 according to the X-axis direction of the screen, convenience of use is satisfactory.

In the embodiment, the processor 11 may cause the display 141 to display the image 21 of the second key layout such that, for example, the numeric key of “4” is located in the touch position Pb, the numeric key of “5” is located in the touch position Pa, and the numeric key of “6” is located in the touch position Pc.

In the embodiment, the number of fingers with which the long-press operation is performed is not limited to three. For example, the operator may perform the long-press operation with two fingers. In that case, the processor 11 only has to cause the display 141 to display the image 21 of the second key layout such that the numeric key of “5” is located in one touch position, for example, the touch position Pa, and the numeric key of “4” is located in the other touch position, for example, the touch position Pb.

In the embodiment, the arrangement of the numeric keys provided in the telephone is illustrated as the regular arrangement. Concerning this point, as explained above, the arrangement in which the numeric keys of “1” to “9” are horizontally or vertically arranged from the upper left, the upper right, the lower left, or the lower right in the order of “1” to “9” may be set as the regular arrangement. For example, a key arrangement applied to an electronic desktop calculator, that is, a key arrangement including the numbers “0” to “9” and the arithmetic operation symbols may be set as the regular arrangement. By applying such a key arrangement, the input device can be applied as an input device for a calculator of a soft key type.

If the image 21 of the second key layout is grasped as an image exclusive for a visually impaired person, the image 21 does not always have to be displayed to be visually recognizable. If the image 21 is not displayed to be visually recognizable, even if an outsider steals a glance at an operation for inputting a password, for example, from behind a visually impaired person, it is difficult to learn the input password.

Besides, several embodiments are explained above. However, the embodiments are presented as examples and are not intended to limit the scope of the present disclosure. These new embodiments can be implemented in other various forms. Various omissions, substitutions, and changes can be made without departing from the spirit of the present disclosure. These embodiments and modifications of the embodiments are included in the scope and the gist of the present disclosure and included in the concepts described in claims and the scope of equivalents of the present disclosure.

What is claimed is:

1. An input device comprising:
a display including a screen; and
a processor configured to:
cause the screen to display a first key layout in which a set of numeric keys is arranged in a first arrangement;
perform a first determination of whether a part on the screen is specified,
if a first part of the screen has been specified, cause the screen to display a second key layout in which the set of numeric keys is arranged in a second arrangement, and
receive, based on an operation on the first key layout or the second key layout, an input of at least one input numeric key of the numeric keys.

2. The input device of claim 1, wherein the processor is further configured to cause the screen to display the second key layout based on a positional relation between the first part and at least one other part of the screen.

3. The input device of claim 1, wherein the processor is further configured to:
inform when the first part is inappropriate for display of the second key layout; and
not cause the screen to display the second key layout when the first part is inappropriate for display of the second key layout.

4. The input device of claim 1, wherein the first determination is a long-press operation.

5. The input device of claim 1, further comprising an interface configured to output data of the at least one input numeric key to a settlement device.

6. The input device of claim 1, wherein:
the first arrangement includes a first row of the numeric keys that is not arranged in numerical order; and
the second arrangement includes a plurality of second rows of the numeric keys, the numeric keys in each of the second rows arranged being in numerical order.

7. The input device of claim 1, wherein:
the screen has a first width and a first height; and
the first key layout is defined by a second width and a second height, the second width being less than the first width, and the second height being less than the first height.

8. The input device of claim 7, wherein the second key layout is defined by a third width and a third height, the third width being less than the first width, and the third height being less than the first height.

9. The input device of claim 8, wherein:
the second height is equal to the third height; and
the second width is equal to the third width.

10. The input device of claim 1, wherein the processor is further configured to:
perform a second determination of whether a second part different from the first part on the screen is specified; and
receive a second indication that the second part is specified, and
cause the screen to display, with the first part set as a first reference and the second part set as a second reference, the second key layout.

11. The input device of claim 10, wherein the processor is further configured to:
cause the screen to display the first key layout in a first orientation; and
cause the screen to display, with the first part set as the first reference and the second part set as the second reference, the second key layout in a second orientation that is different from the first orientation.

12. A method of controlling an input device including a display with a screen, the method comprising:
causing the screen to display a first key layout in which a set of numeric keys are arranged in a first arrangement;
determining whether a part on the screen is specified;
if a first part on the screen is specified, causing the screen to display a second key layout in which the set of numeric keys is arranged in a second arrangement; and
receiving, based on an operation on the first key layout or the second key layout, an input of at least one input numeric key of the numeric keys.

13. The method of claim 12, further comprising causing the screen to display the second key layout based on a positional relation between the first part and at least one other part of the screen.

14. The method of claim 12, further comprising providing an informing output when the first part is inappropriate for display of the second key layout.

15. The method of claim 12, wherein:
the first arrangement includes a first row of the numeric keys that is not arranged in numerical order; and
the second arrangement includes a plurality of second rows of the numeric keys, the numeric keys in each of the second rows arranged in numerical order.

16. The method of claim 12, wherein:
the screen has a first width and a first height; and
the first key layout is defined by a second width and a second height, the second width being less than the first width, and the second height being less than the first height.

17. The method of claim 12, further comprising, if a second part on the screen is specified, causing the screen to display the second key layout.

18. The input device of claim 10, wherein:
the screen is caused to display the first key layout in a first orientation; and
the screen is caused to display the second key layout in a second orientation that is different from the first orientation.

19. An input device comprising:
a display including a screen; and
a processor configured to:
perform a first determination of whether a part on the screen is specified
if a first part of the screen has been specified by a first determined operation, cause the screen to display, a first key layout in which a set of numeric keys is arranged in a first arrangement, and
if a second part of the screen has been specified by a second determined operation, cause the screen to display, a second key layout in which the set of numeric keys is arranged in a second arrangement different from the first arrangement.

20. The input device of claim 19, wherein the processor is further configured to inform when a third part specified by a third determined operation is inappropriate for display of a third key layout in which the set of numeric keys is arranged.
